(19) United States
(12) Patent Application Publication
(10) Pub. No.: US 2024/0248301 A1
(43) Pub. Date: Jul. 25, 2024

(54) SYSTEMS AND METHODS FOR MOBILE AND STATIC BIOMETRIC MOVEMENT TRACKING

(71) Applicant: Regeneron Pharmaceuticals, Inc., Tarrytown, NY (US)

(72) Inventors: Matthew F. WIPPERMAN, Brooklyn, NY (US); Bharatkumar KOYANI, Cary, NC (US); Samuel STUART, Whitley Bay (GB); Rinol ALAJ, Jersey City, NJ (US); Oren LEVY, New York, NY (US); Sara HAMON, Darien, CT (US); Erica CHIO, New York, NY (US)

(73) Assignee: Regeneron Pharmaceuticals, Inc., Tarrytown, NY (US)

(21) Appl. No.: 18/420,090

(22) Filed: Jan. 23, 2024

Related U.S. Application Data
(60) Provisional application No. 63/481,023, filed on Jan. 23, 2023.

(51) Int. Cl. G02B 27/00

(52) U.S. Cl. CPC G02B 27/0093

(57) ABSTRACT

Systems and techniques disclosed herein include receiving static device data in response to detected first biometric movements, receiving mobile device data in response to detected second biometric movements, applying an analysis algorithm to the static data to determine static attributes, applying the analysis algorithm to the mobile data to determine mobile attributes, comparing the static attributes to the mobile attributes, and determining a modification action based on the comparing. A mobile device may be validated based on the determining that the static attributes are within a threshold parameter of the mobile attributes.

### CROSS-REFERENCE TO RELATED APPLICATIONS

This application claims priority to U.S. Provisional Application No. 63/481,023, filed on Jan. 23, 2023, the entirety of which is incorporated by reference herein.

### TECHNICAL FIELD

Aspects of the disclosed subject matter are generally directed to systems and methods for comparing characteristics of biometric events detected using various biometric devices, e.g., stationary and mobile biometric devices, by applying a data processing algorithm. More specifically, aspects of the disclosed subject matter are directed to comparing characteristics of saccadic events detected using differing eye tracking devices, e.g., stationary and wearable eye-trackers, by applying a data processing algorithm.

### INTRODUCTION

Eye movements are often studied for indication of underlying neural, cognitive, and visual processing that provides insight into how the brain and eyes function. Eye-tracking technology has progressed from invasive, time-consuming, and costly (e.g., approximately USD $40 k) methods to non-invasive rapid eye-tracking devices. Modern infrared eye-trackers can be used to study eye movements during static (seated, fixed location) tasks that are well controlled to examine specific eye movements and characteristics, but technological advancements now allow for lower-cost (e.g., approximately USD $5 k) eye-tracking using mobile (e.g., wearable) devices that can be used in any environment. Mobile eye-trackers may also enable other advantages such as, but not limited to, improved patient experience, easier adoption at larger scale, ability to take measurements in real-world settings, and/or more frequent assessments.

This introduction section is provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Aspects of the present disclosure relate to biometric movement based analysis. In one aspect, the present disclosure is directed to a method including: receiving static device data in response to detected first biometric movements; receiving mobile device data in response to detected second biometric movements; applying an analysis algorithm to the static device data to determine static attributes; applying the analysis algorithm to the mobile device data to determine mobile attributes; comparing the static attributes to the mobile attributes; and determining a modification action based on the comparing.

In another aspect, the present disclosure is directed to a method including: receiving static device data in response to detected first biometric movements; receiving mobile device data in response to detected second biometric movements; applying an analysis algorithm to the static device data to determine static attributes; applying the analysis algorithm to the mobile device data to determine mobile attributes; determining that the static attributes are within a threshold parameter of the mobile attributes; and validating a mobile device based on the determining that the static attributes are within a threshold parameter of the mobile attributes.

According to another aspect, a system may include: a static device comprising at least one first sensor to detect first biometric movements; a mobile device comprising at least one second sensor to detect second biometric movements; a processor; a computer-readable data storage device storing instructions that, when executed by the processor, cause the system to: receive static device data based on the first biometric movements; receive mobile device data based on the second biometric movements; apply an analysis algorithm to the static device data to determine static attributes; apply the analysis algorithm to the mobile device data to determine mobile attributes; compare the static attributes to the mobile attributes; and determine a modification action based on the comparing.

According to another aspect, a system may include: a static device comprising at least one first sensor to detect first biometric movements; a mobile device comprising at least one second sensor to detect second biometric movements; a processor; a computer-readable data storage device storing instructions that, when executed by the processor, cause the system to: receive static device data based on the first biometric movements; receive mobile device data based on the second biometric movements; apply an analysis algorithm to the static device data to determine static attributes; apply the analysis algorithm to the mobile device data to determine mobile attributes; determine that the static attributes are within a threshold parameter of the mobile attributes; and validate the mobile device based on the determining that the static attributes are within a threshold parameter of the mobile attributes.

In another aspect, the present disclosure is directed to a method including: receiving static device data in response to detected first biometric movements; receiving mobile device data in response to detected second biometric movements; applying an analysis algorithm to the static device data to determine static attributes; applying the analysis algorithm to the mobile device data to determine mobile attributes; and outputting at least one of the static attributes or the mobile attributes. At least one of the static attributes or the mobile attributes may be output as an endpoint in a clinical trial.

In accordance with any of these aspects, the static device data may be generated by a static device. The mobile device data may be generated by a mobile device. The mobile device may be a wearable device. The first biometric movements and the second biometric movements may be saccades. The static device data or the mobile device data may be raw data. The analysis algorithm may be a Velocity-Threshold Identification (I-VT) eye-tracker algorithm. The static device may operate at a higher resolution than the mobile device. The static device may operate at a higher refresh-rate than the mobile device. The first biometric movements may be the same as the second biometric movements. The first biometric movements or the second biometric movements may be detected during performance of a task. The first biometric movements or the second biometric movements may be detected during performance of a memory saccade task. The static attributes or the mobile attributes may include one or more of a velocity, an amplitude, a duration, or a latency. The static attributes or the mobile attributes may include one or more of a saccadic velocity, a saccadic amplitude, a saccadic duration, or a saccadic latency. The static attributes or the mobile attributes may include one or more of a fixation attribute, a target shown attribute, a maintain fixation attribute, a saccade attribute, or a correction attribute. The static attributes or the mobile attributes may include one or more of a time to first saccade, a largest first saccade, a largest non-first saccade, total saccades, or a number of saccades within a duration.

### BRIEF DESCRIPTION OF THE FIGURES

The accompanying drawings, which are incorporated in and constitute a part of this specification, illustrate various examples and, together with the description, serve to explain the principles of the disclosed examples and embodiments.

Aspects of the disclosure may be implemented in connection with embodiments illustrated in the attached drawings. These drawings show different aspects of the present disclosure and, where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure.

Moreover, there are many embodiments described and illustrated herein. The present disclosure is neither limited to any single aspect or embodiment thereof, nor is it limited to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended to reflect or indicate the embodiment(s) is/are “example” embodiment(s).

FIG. 1 shows a screen sequence for memory saccade testing, in accordance with aspects of the present disclosure.

FIG. 2 shows saccade characteristic plots, in accordance with aspects of the present disclosure.

FIG. 3A shows saccade amplitude differences between mobile and static device data, in accordance with aspects of the present disclosure.

FIG. 3B shows saccade duration differences between mobile and static device data, in accordance with aspects of the present disclosure.

FIG. 3C shows saccade velocity differences between mobile and static device data, in accordance with aspects of the present disclosure.

FIG. 4A shows saccade latency differences between mobile and static device data, in accordance with aspects of the present disclosure.

FIG. 4B shows saccade latency differences between mobile and static device data, for a same participant, in accordance with aspects of the present disclosure.

FIG. 4C shows a table including saccade data for a static device and a wearable device, in accordance with aspects of the present disclosure.

FIGS. 5A-5D show saccade data based on mobile and static devices, in accordance with aspects of the present disclosure.

FIG. 6 is a flowchart for comparing static attributes to mobile attributes, in accordance with aspects of the present disclosure.

FIG. 7 is a data flow for training a machine learning model, according to one or more embodiments.

FIG. 8 is an example diagram of a computing device, according to one or more embodiments.

### DETAILED DESCRIPTION

Reference will now be made in detail to examples of the present disclosure, which are illustrated in the accompanying drawings. Wherever possible, the same reference numbers will be used throughout the drawings to refer to the same or like parts. The term “distal” refers to a portion farthest away from a user when introducing a device into a subject. By contrast, the term “proximal” refers to a portion closest to the user when placing the device into the subject. In the discussion that follows, relative terms such as “about,” “substantially,” “approximately,” etc. are used to indicate a possible variation of ±10% in a stated numeric value.

As used herein, the terms “comprises,” “comprising,” “includes,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” In addition, the terms “first,” “second,” and the like, herein do not denote any order, quantity, or importance, but rather are used to distinguish an element or a structure from another. Moreover, the terms “a” and “an” herein do not denote a limitation of quantity, but rather denote the presence of one or more of the referenced items.

Aspects of the disclosed subject matter are generally directed to receiving signals generated based on a body component of an individual. The signals may be or may be generated based on electrical activity, physical activity, biometric data, movement data, reflex data, or any attribute of an individual's body, an action associated with the individual's body and/or organ, reaction of the individual's body or organ, or the like. The signals may be generated by one or more signal capture devices (e.g., static or mobile devices) that may capture the signals using one or more sensors (e.g., visual sensors, optical sensors, cameras, infrared sensors, etc.). For example, aspects of the disclosed subject matter are directed to methods for profiling biometric movements in a subject using a wearable biometric device (a mobile device) and/or a static device.

Traditionally, static eye-tracking devices have been high resolution (e.g., approximately >1,000 Hz), providing accurate results from standardized tasks, whereas mobile eye-tracking devices have been cumbersome and low resolution (e.g., approximately 25-60 Hz) due to a mobility-resolution trade-off in eye-tracking technology. The limitations in resolution have meant that not all eye movement characteristics could be captured with mobile eye-tracking devices. For example, approximately 50 Hz is adequate to detect a saccade, but approximately >100 Hz is needed to accurately measure velocities, durations, latencies, or amplitudes. However, mobile eye-tracking devices have reduced in physical size where they are now no bigger than a pair of glasses with a connection to a smart phone, and increased in analytical resolution (e.g., now approximately >100 Hz), allowing acquisition of comprehensive eye movement characteristics.

Despite this increased resolution of mobile eye-tracking hardware, there have been few studies that have examined the performance of standardized eye movement tasks using such devices. This is partially attributable to mobile eye-tracking devices lacking automated and standardized algorithms to provide eye movement characteristics. Such devices typically provide raw time-coordinate data, but few have in-built algorithms to provide fixational or saccadic outcomes, whereas static eye-trackers have been widely used alongside in-built algorithms and standardized tasks on screens to provide detailed and controlled eye movement outcomes automatically.

A commonly used standardized task is the memory-guided saccade (MS) task, which involves making saccadic eye movements to remembered target locations in the absence of visual stimuli, with underlying algorithms to run the stimuli on the screen and obtain the saccadic characteristics simultaneously. A challenge of analyzing data from MS tasks is that different eye-tracking devices have different underlying algorithms, meaning that results can be vastly different for an identical task due to semi-arbitrary thresholding. Static eye-tracking systems that have standardized tasks and algorithms in-built are typically costly, and use ‘black-box’ algorithms to provide data, whereas mobile devices are lower cost and allow full control over raw data.

To determine whether a mobile eye-tracking device can provide similar data to a static eye-tracking device, MS task performance on two eye-tracking systems may be compared using the same eye movement detection algorithm, as disclosed herein. MS task performance completed on a computer screen and monitored with a static infrared eye-tracker (e.g., Tobii pro Spectrum, 1,200 Hz) may be compared to a mobile infrared eye-tracker (e.g., Argus Science ET vision, 180 Hz) with data processing using the same algorithm (I-VT). Determining if mobile eye-trackers are comparable to a high-end static eye-tracker may provide insight into whether lower-cost mobile devices could be used within low-resource settings (e.g., clinical, community or home-based settings), a prerequisite goal to their use in clinical development.

Implementations of the disclosed subject matter include a static system (e.g., surface based or fixed location system) and a movable (e.g., wearable) system for identifying and analyzing biometric movements in human subjects. Systems and techniques disclosed herein may be used to resolve device based detection gaps in patients presenting with cognitive, visual, and/or neural processing disorders. In particular, a noninvasive wearable biometric device (e.g., an eye tracking device) is disclosed to detect patient movements such as, for example, eye movements, organ movements, body movements, biometric responses, reflexes, etc.

According to implementations of the disclosed subject matter, biometric movements of a user may be detected using a static biometric device and may also be detected using a mobile biometric device (e.g., a wearable device). The biometric movements may be detected by a first device (e.g., the static biometric device or the mobile biometric device) at a first time and by a second device (e.g., the static biometric device or mobile biometric device) at a second time. Alternatively, biometric movements may be detected by both the first device and the second device at approximately the same time (e.g., by positioning the static and mobile device on or proximate to a user at the same time).

Biometric movements may be detected by one or more respective device sensors in response to a task performed by the user. This disclosure generally describes biometric movement related to saccades. However, it will be understood that the subject matter disclosed herein may be applied to any biometric movement including, but not limited to, eye movement, organ movement, body part movement, reflexes, eardrum movements, neural changes, or the like or a combination thereof.

According to implementations, an analysis algorithm (e.g., a Velocity-Threshold Identification (I-VT) algorithm) may be applied to raw biometric movement data generated by a static and/or mobile device. The same analysis algorithm may be applied to the raw biometric movement data detected using a static biometric device and a mobile biometric device. Attributes of the biometric movement (e.g., amplitude, velocity, duration, latency, etc.) may be evaluated based on the application of the analysis algorithm, as further disclosed herein.

A determination may be made whether the attributes identified based on the mobile biometric device data are comparable to the attributes identified based on the static biometric device data. For example, a determination may be made whether the attributes identified based on the mobile biometric device (mobile attributes) are within one or more threshold parameters of the attributes identified based on the static biometric device (static attributes).

The mobile biometric device may be validated based on a determination that the mobile attributes are within the threshold parameters of the static attributes. Alternatively, or in addition, the analysis algorithm may be modified to generate a modified analysis algorithm. Application of the modified analysis algorithm to subsequent mobile biometric device data may result in mobile attributes that more closely match the attributes output from application of the analysis algorithm to static biometric device data. Accordingly, a modified analysis algorithm may be generated to align results of a mobile biometric device with a static biometric device.

Alternatively, or in addition, changes to design attributes of a mobile device may be output based on comparing mobile attributes to static attributes. For example, based on the comparison of mobile attributes and static attributes, a determination may be made that a mobile device (e.g., wearable device) resolution is insufficient. Alternatively, or in addition, a minimum resolution may be determined based on comparing mobile attributes of a given mobile device to static attributes of a given static device. This process may be iterated to test an updated design attribute until, for example, mobile attributes (e.g., having a modified design) are within the threshold parameters of static attributes. Such iteration may be implemented using an updated physical mobile devices and/or by stimulating an updated mobile devices (e.g., using stimulation software).

According to implementations of the disclosed subject matter, one or more factors (e.g., participant-related factors, technology-related factors, protocol-related factors, etc.) that contribute to differences in mobile attributes and static attributes may be identified based on comparing mobile attributes and static attributes. Additionally, effects and/or a degree of such effects of one or more such factors that contribute to differences in mobile attributes and static attributes may be identified based on comparing mobile attributes and static attributes. Such effects may include changes in characteristics (e.g., amplitude, degree, phase, frequency, etc.) of mobile attributes in comparison to static attributes.

Saccades are rapid eye movements that enable the eyes to shift fixation from one visual target to another. Saccadic eye movements are disrupted in clinical populations where neural, cognitive, or sensory function is impacted and therefore convenient measurement of these movements could serve as a meaningful functional endpoint in clinical trials. Traditionally, eye movements have been examined using costly high-resolution, high refresh-rate (e.g., approximately >1,000 Hz) static (patient seated in fixed location) eye-tracking devices, but recent developments have led to lower-cost mobile eye-trackers with adequate resolution (e.g., approximately >100 Hz) for eye movement measurement, both of which may use infrared to measure changes in eye movements. Implementations of the disclosed subject matter include determining whether wearable devices are comparable to static eye-trackers, particularly during standardized testing. According to implementations disclosed herein, characteristics of saccadic events derived with the same data processing algorithm across stationary and wearable eye-trackers may be compared. Determining whether mobile devices (e.g., lower-cost mobile eye-trackers) compare to static devices (e.g., high-end static eye-trackers) may provide insight into whether this technology can be deployed in low-resource clinical settings (e.g., passive monitoring).

According to an implementation, eye movements with a wearable eye-tracking device (e.g., Argus ETVision Glasses, 180 Hz) may be separately recorded from eye movements with a screen-based stationary device (e.g., Tobii Spectrum, 1,200 Hz) during a memory-guided saccade (MS) test in 13 healthy adult participants (aged 44-74 years). To detect fixations and saccades, a Velocity-Threshold Identification (I-VT) eye-tracker algorithm is applied to raw eye-tracking data from both systems. Saccade amplitude, velocity, duration, and latency between the screen-based and wearable eye-tracking devices are recorded.

As discussed herein, a wearable device may have a higher number of non-physiological (artefactual) saccades compared to the static device, especially during Fixation portions of the MS task (around 10% vs <1%). In general, good agreement between the two devices when measuring saccade duration, amplitude, and velocity in the same subjects is observed. In the MS task a learning effect on evaluation of saccade latency over subsequent trials (indicating that subjects were likely learning to do the task better) is observed, as well as overall faster saccade reaction times with the static device, likely indicating greater accuracy. Additionally, for the MS task, both devices identified that for a majority of trials, the largest saccade was the first saccade (static, 73%; mobile, 66%), however, both devices also demonstrated smaller eye movements before (if the largest saccade was not first) and after the largest saccade.

According to implementations disclosed herein, it is demonstrated that both eye-tracking systems (e.g., a mobile device and static device) can provide saccadic outcomes from an algorithm, but raw data and outcomes from the mobile eye-tracker are likely impacted by a range of internal (e.g., participant-related) and external (e.g., technology and study protocol) factors that led to artefacts. The impact of these factors on the eye-tracking data analysis algorithms before deployment of such technology within clinical, community or home-based settings, may be investigated.

Eye tracking may be a valuable tool for understanding cognitive, visual, and neural processing, particularly in clinical conditions that can impact these processes, such as aging, neurological disorders, and ophthalmological issues. The development of mobile, low-cost eye-tracking devices may provide new opportunities for research and clinical trials by enabling more widespread adoption and/or measurement in real-world settings. According to implementations, data from a traditional, static eye-tracking device may be compared to data from a mobile eye-tracking device using the same data processing algorithm, in healthy adults during a memory-guided saccade task. According to implementations, mobile eye-trackers may provide similar (though imperfect) saccadic outcomes to static devices but are more prone to errors due to factors such as calibration, equipment set-up, and environmental factors.

It will be understood that although static and mobile systems are generally disclosed herein in relation to eye tracking, the techniques disclosed herein may be applied to any method for comparing characteristics of biometric events, detected using stationary and mobile (e.g., wearable) biometric devices, that are analyzed using a data processing algorithm. Accordingly, the techniques disclosed herein are not limited to eye tracking and/or any specific algorithms.

Reference will now be made in detail to specific implementations illustrated in the accompanying drawings. In the following detailed description, numerous specific details are set forth to provide a thorough understanding of the disclosure.

However, it will be apparent to one of ordinary skill in the art that implementations may be practiced without these specific details. In other instances, known methods, procedures, components, circuits, and networks have not been described in detail so as not to unnecessarily obscure aspects of the implementations.

### EXAMPLE

### Methods

In an example experiment conducted in accordance with the techniques disclosed herein, a total of N=13 participants (4 female & 9 male, aged between 44-74 years) were enrolled (generally referred to as the “study”). All participants were healthy adults who reported normal or corrected-to-normal vision.

Each study session included two repetitions of a task battery followed by a brief user experience questionnaire to assess the usability of wearable eye-tracking glasses/device. Participants completed a memory-guided saccade (MS) task. Participants' eye movements were tracked with a static eye-tracker (Tobii Pro Spectrum 1,200 Hz) and with a pair of wearable eye-tracking glasses (Argus Science ET Vision 180 Hz). The static eye-tracker was a bar that attaches to the screen that the stimulus was presented on, whereas the mobile device was plugged into a USB port to synchronize the eye-tracking data to the presented stimulus. Prior to starting the task, eye-tracker calibration was performed for each technology. Eye-tracking calibration for the Tobii session was done using iMotions' built-in 9-point calibration process. Calibration for the Argus session were done using a single-point calibration procedure prescribed by Argus Science.

The MS task was programmed in MATLAB (Mathworks) using Psychtoolbox-3 on a PC running Windows 10. The task was presented on a 24-inch external monitor (1920×1080 resolution) for both Tobii and Argus sessions, while participants were seated approximately 60 cm away from the monitor. Stimulus presentation and response collections were controlled by Psychtoolbox-3 using MATLAB R2020b, while concurrent eye-tracking data was collected using iMotions 8.2 for Tobii sessions and ETRemote for Argus sessions. Argus scene videos and eye tracking data were imported into iMotions post data collection for further analysis.

### Memory Saccade (MS) Task

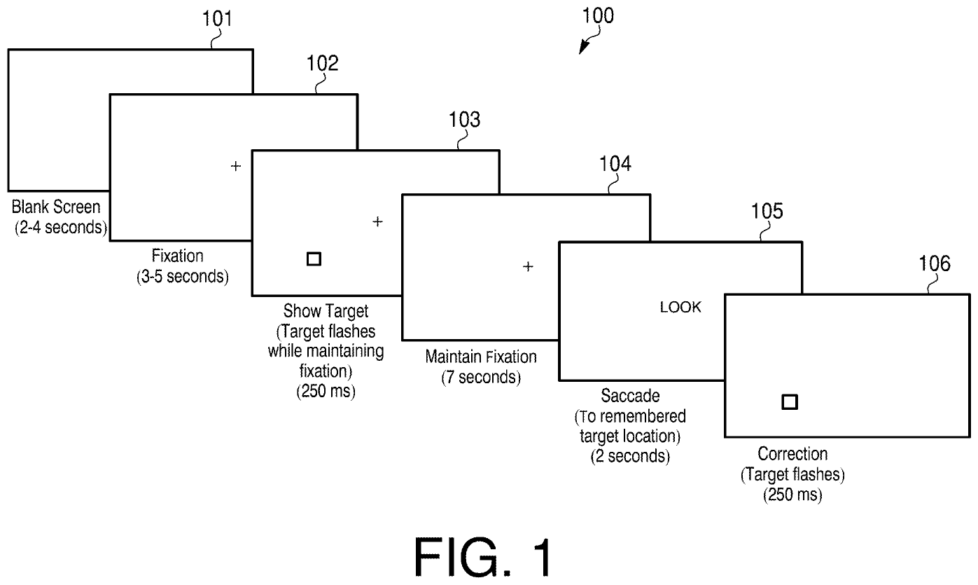

As shown in screen sequence 100 of FIG. 1, an MS task was used to compare the saccadic and fixation outcomes from the static Spectrum and Argus wearable eye-tracking devices. Each trial during the memory-based saccade task includes 6 steps. First, a jittered intertrial interval (e.g., approximately 2-4 seconds) began each trial (blank screen 101). Then, a green cross would appear in the middle of subsequent screen 102 and participants were asked to orient and maintain their attention there (Fixation). This specific attention orientation step was jittered to last between approximately 3-5 seconds before the next step would occur in order to alleviate any learned anticipatory behavior of this next step. While participants fixated on the green cross, a white target box, shown in screen 103, would flash peripherally to the green cross at a predetermined angle and distance for approximately 250 milliseconds (Show Target). During this step, participants were instructed to refrain from moving their attention towards the flash and maintain their attention on the green fixation cross. Participants were asked to maintain fixation on the green cross of screen 104 for approximately 7 additional seconds after the target was flashed on screen (Maintain Fixation). After a given amount of time passed, the green fixation cross changed to the word ‘LOOK,’ shown in screen 105, where participants were then instructed to saccade towards the location where they recall seeing the white target had flashed on screen (Saccade). Participants were given approximately 2 seconds to make the saccade and sustain their fixation on the target location. The white target then reappeared for approximately 250 milliseconds for any corrective saccade (Correction), as shown in screen 106.

Screen sequence 100 of FIG. 1 shows an experimental paradigm for memory-based saccade with one sample trial sequence. Participants completed approximately 30 trials for each eye-tracking technology. Location of the targets were randomized across trials. Participants were presented with the following instructions prior to a practice and main study session: “In this task, you will be asked to fixate on a green + centralized on the screen. While you are fixating on the green +, a box will flash in your peripheral vision. Please refrain from looking at this box and maintain your focus on the green +. Then, the green + will disappear, and you will see the word “LOOK”. At this time, please look towards the position of the box that has flashed on the screen. While you are doing this, the box will flash a second time to let you know where it was as feedback to you.”

Participants were provided with instructions about the task prior to starting a practice session, and participants passed the practice session after one try. For the actual study, participants completed 32 trials once with the static Tobii eye-tracker and once with the wearable Argus glasses. Trials were performed in a random order. Typically, one would focus on the task performance during the saccade step, however, data for saccades are presented during each of the steps in FIG. 1 intentionally, to demonstrate the volume of potential biologically relevant data available throughout such a structured task.

### Data Analysis

Raw eye-tracking data were processed in iMotions 8.2 where an I-VT filter was applied prior to further analysis in Python 3. Due to the complex trial nature of the MS task, it was critical that the segments during each trial (e.g., Show Target, Saccade) were identified prior to data analysis. For Tobii sessions, time markers were directly inserted into the data as they occurred during task performance and these time markers were then used to divide each trial into relevant segments for further analyses. For Argus sessions, time markers were generated post data collection by passing each participant's scene recordings into a Python script performing an OpenCV template matching algorithm on each frame of these recordings.

For the eye-tracking devices used in this study, the wearable Argus and static Spectrum, the following parameters with the I-VT algorithm were employed: screen resolution (width×height: Argus: 1280×720; Spectrum: 1920×1080), screen distance (Argus: 100 cm; Spectrum: 60 cm), monitor size (Argus: 90.1; Spectrum: 24), and whether glasses were worn (Argus: true, Spectrum: false). The average time difference between timestamps for the first 100 samples was 5.5 ms for Argus (180 Hz) and 0.8 ms for Spectrum (1200 Hz). The interpolated distance for Argus was 1000, and for Spectrum it was approximately 587.3. The window velocity for both devices was 20. The gap fill, max angle between fixations, max time between fixations, velocity threshold, merge fixations, discard short fixations, and minimum duration of fixations were all set to true, 0.5, 75, 30, true, true, and 60 for both devices, respectively. Both devices had a latency of 0 and noise reduction was set to false for both devices.

### Statistical Analysis

As provided herein, saccade parameter data are plotted on a log 10 scale, derived from the I-VT algorithm for each device. Multiple saccades from the same subject are average and the mean and standard deviation of saccade values are plotted, when representing data from subsequent trials. For boxplots, each box-whisker on the x-axis represents the repeated measurements of a participants' saccade values repeated measurements. The horizontal lines represent each subject's median saccade value, the box indicates the interquartile range (IQR) (Q3-Q1), and the whiskers represent 1.5*IQR.

### Results

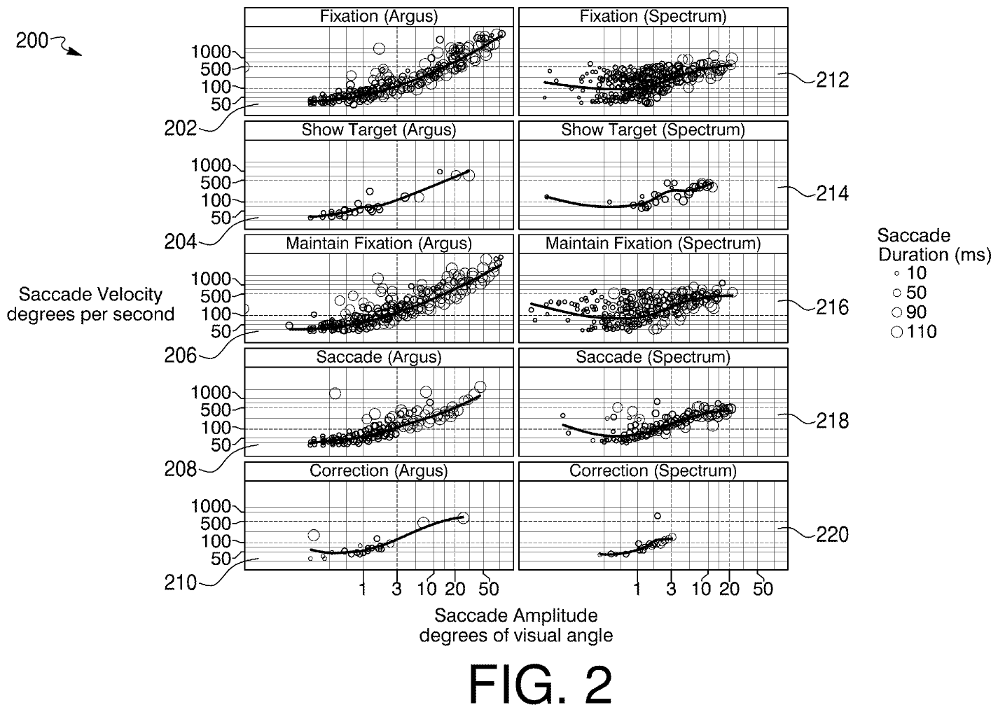

In the study, as shown plots 200 in FIG. 2, several standard saccade characteristics are plotted during each segment of the MS task, rather than just focusing on the “Saccade” portion. By plotting all segments of the task, a wider range of potentially interesting and valuable data, including variations in saccade velocity, amplitude, and duration, can be visualized and which can provide a more comprehensive understanding of the saccadic performance of the device and variability even within healthy volunteers.

In plots 200, saccade velocity, plotted on the y-axis, refers to the speed at which the eye moves during a saccade (degrees per second). Saccade amplitude, plotted on the x-axis, refers to the distance of the eye movement during a saccade (degrees). Each dot in the plot represents one saccade as determined using the I-VT filter, and the size of the dot indicates the duration of the saccade (milliseconds). The dotted lines in the plot represent the typical range of saccade velocity and saccade amplitude in healthy controls. Typical saccade peak velocities range from approximately 300 to approximately 400 degrees per second, and typical saccade amplitudes range from approximately 3 to about approximately 15-20 degrees of visual angle. In FIG. 2, these values are shown on a per-subject basis for both devices.

Plots 200 of FIG. 2 show common saccade parameters for the wearable Argus and static Spectrum devices during each MS task segment. Saccade velocity (deg/s) is plotted as a function of saccade amplitude (degrees), each dot represents one saccade as determined using the same I-VT parameters filter (Methods), and the size of the dot indicates the duration of the saccade (milliseconds). Dotted lines represent the typical normal ranges in healthy controls for saccade velocity and saccade amplitude. The data represent all subjects and trials pooled together, with the intention of representing an overview of saccadic data that may be collected during the MS task.

It is observed that many saccade values were higher in the Argus device for saccade velocity and amplitude compared to the Spectrum. Saccades of artefactually high amplitude or velocity were classified as non-physiologic saccades, defined as those with saccade amplitude greater than approximately 20 degrees, and velocity greater than approximately 750 degrees per second. The proportion of non-physiologic saccades for each device were qualified. The results of this analysis showed that during the “Fixation” segments 202 and 212, the percentage of non-physiological saccades was 10.91% for the Argus device and 0.15% for the Spectrum device. During the “Maintain Fixation” segments 206 and 216, the percentage of non-physiological saccades was 7.58% for the Argus device and 0% for the Spectrum device. During the “Saccade” segments 208 and 218, the percentage of non-physiological saccades was 1.14% for the Argus device and 0% for the Spectrum device. Thus, the Spectrum device consistently detected fewer non-physiologic saccades compared to the Argus device. “Show Target” segments 204 and 214 as well as “Correction” segments 210 and 220 were also plotted, as shown in plots 200 of FIG. 2.

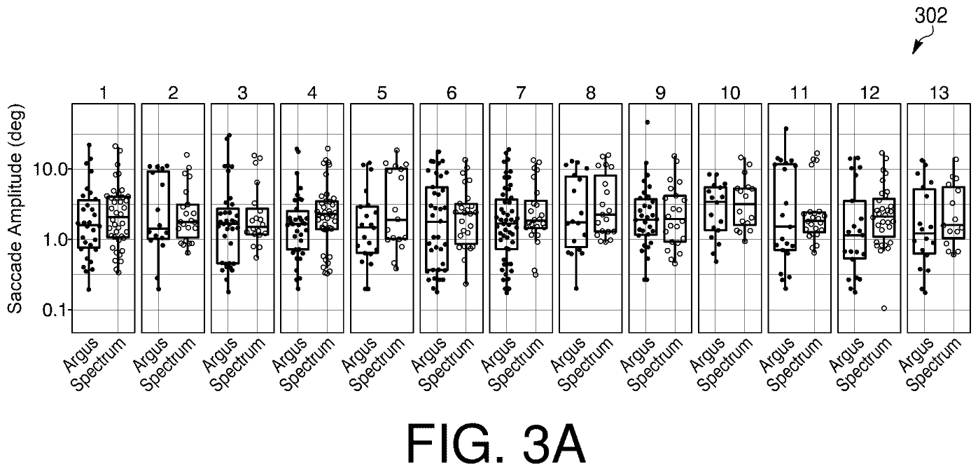

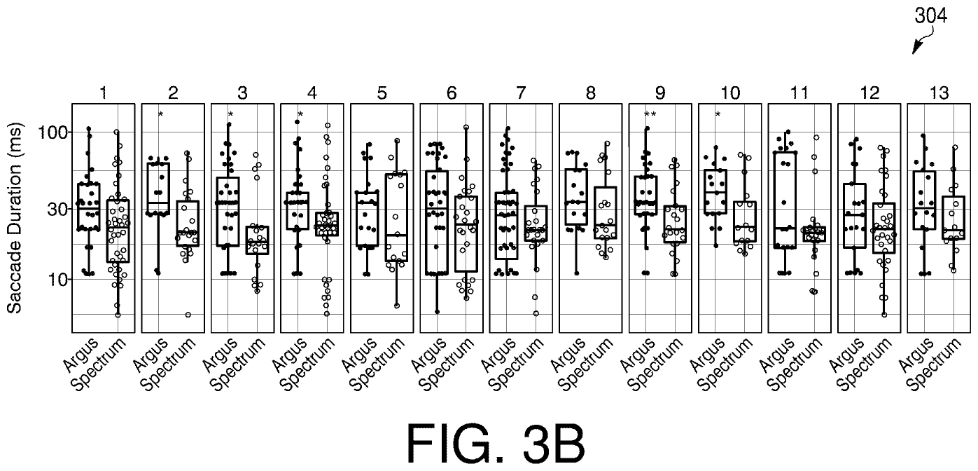

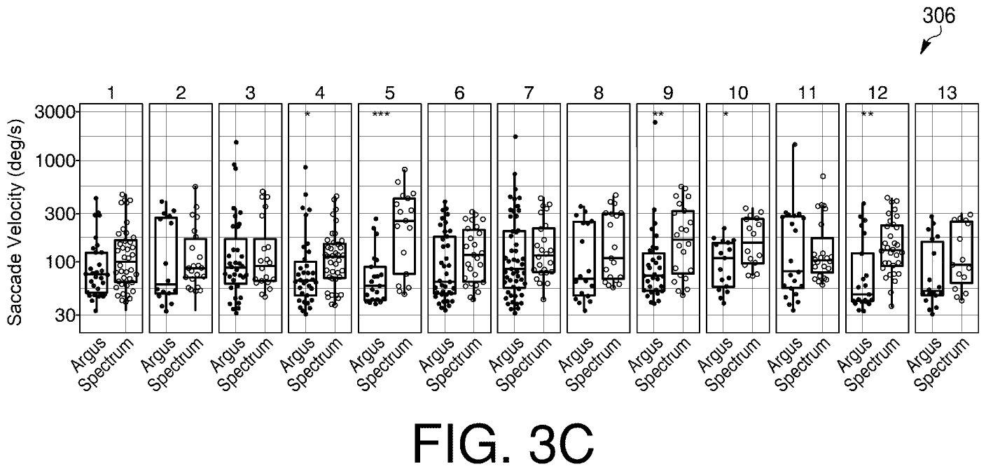

To compare how the saccadic parameters differed between devices for the same participant, saccade amplitude (as shown in plots 302 of FIG. 3A), saccade duration (as shown in plots 304 of FIG. 3B), and saccade velocity (as shown in plots 306 of FIG. 3C) are plotted for each participant. In general, variability both within participants (for the same device), and minor but significant differences between the two devices for some participants for some parameters are observed.

As shown in FIGS. 3A-3C, saccadic values are shown for each subject across devices. Values for saccade amplitude, duration, and velocity for each subject, during the saccade portion of the MS task. The data is shown for both the Spectrum and Argus devices, for each subject.

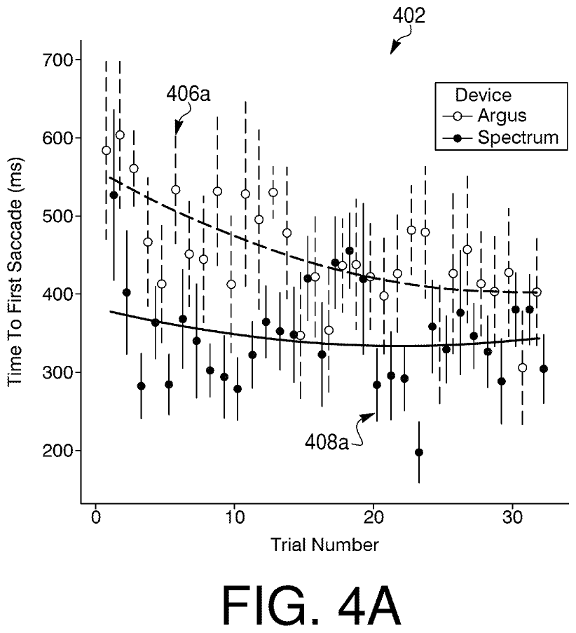

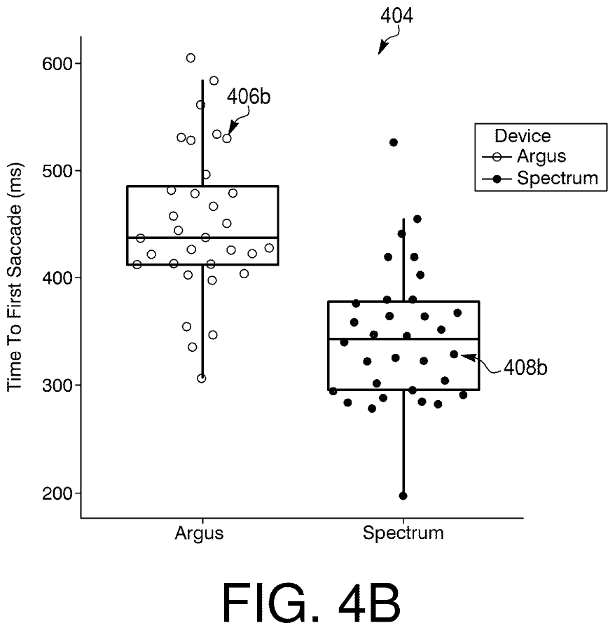

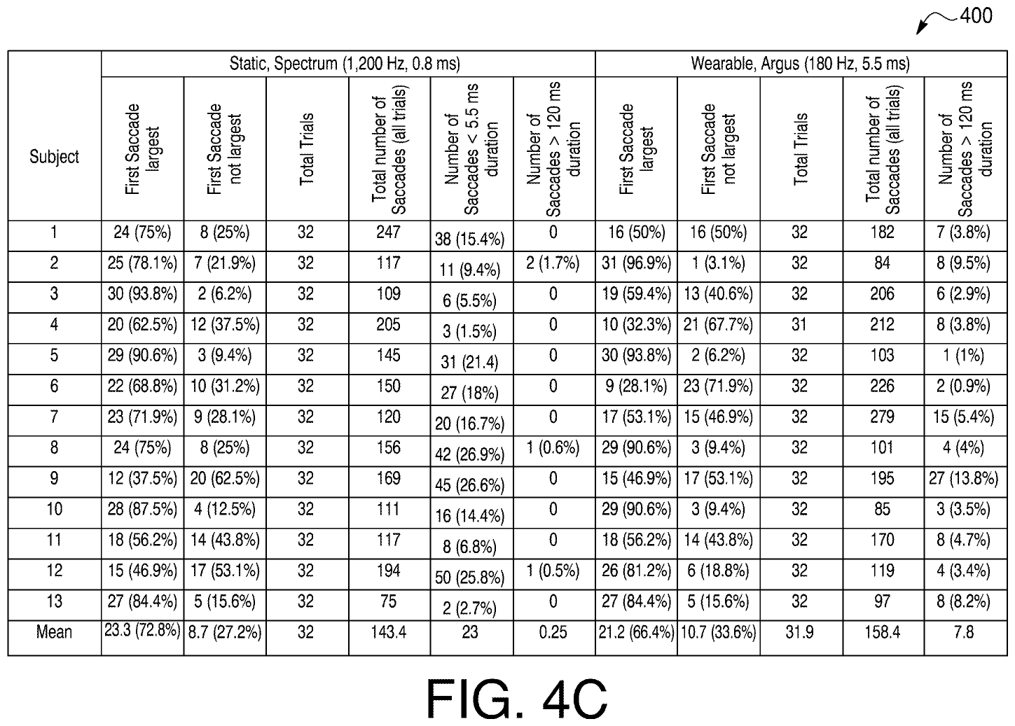

To compare the accuracy of the wearable eye-tracking device to the static device, saccade latency during the Saccade portion of the MS task was analyzed. Saccade latency is the time interval between the onset of the “LOOK” visual stimulus, and the initiation of a saccadic eye movement in response to that stimulus. There was generally a difference between the two devices when measuring saccadic latency, as shown in chart 402 of FIG. 4A, and observed what is likely a learning effect with the eye response becoming faster in subsequent trials. Additionally, there was a large degree of within-subject variability between the subsequent trials, potentially due to a fatigue effect. When pooling the saccade latency values across all 32 trials for the same participant, as shown in chart 404 of FIG. 4B, a difference between the Argus and Spectrum devices in terms of saccade latency is observed.

FIGS. 4A and 4B show time to first saccade during the LOOK portion of the MS task. In chart 402 of FIG. 4A, for each trial in the MS task with both the Spectrum (shown via plot 408a) and Argus devices (shown via plot 406a), the time to first saccade was calculated (e.g., Saccade latency, milliseconds). For each participant and each device, saccade latency is averaged, and the mean and standard deviation are plotted. In chart 404 of FIG. 4B, average saccade latency was qualitatively different between the Spectrum (shown via plot 408b) and Argus devices (shown via plot 406b), with smaller saccade latency (faster reaction time) observed in the Spectrum.

Next, for each trial of the memory-guided saccade task, the sequence of saccades is analyzed to determine if the first saccade was the largest saccade or not. It was expected that subjects would intentionally look towards the target immediately after seeing the “LOOK” stimulus during the Saccade portion of the MS task, and that this would be the first (and potentially only) event observed during this portion of the task. In general, it was found that for both the static and wearable eye-tracking devices, the largest saccade was typically the first saccade in a majority of cases (73% for the static device and 66% for the wearable device, as shown Table 400 of FIG. 4C).

In Table 400 of FIG. 4C, each row represents a subject, with columns indicating saccade data for the static Spectrum device and the wearable Argus device. The columns correspond to the Saccade portion of the MS task, and the cutoffs are to make the ranges of data comparable between the two devices since they have different sampling frequencies.

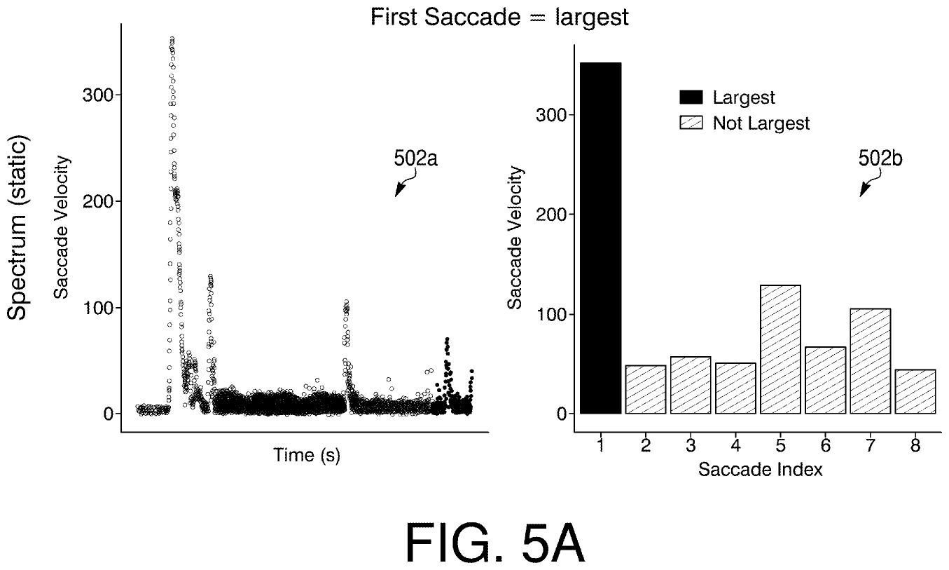

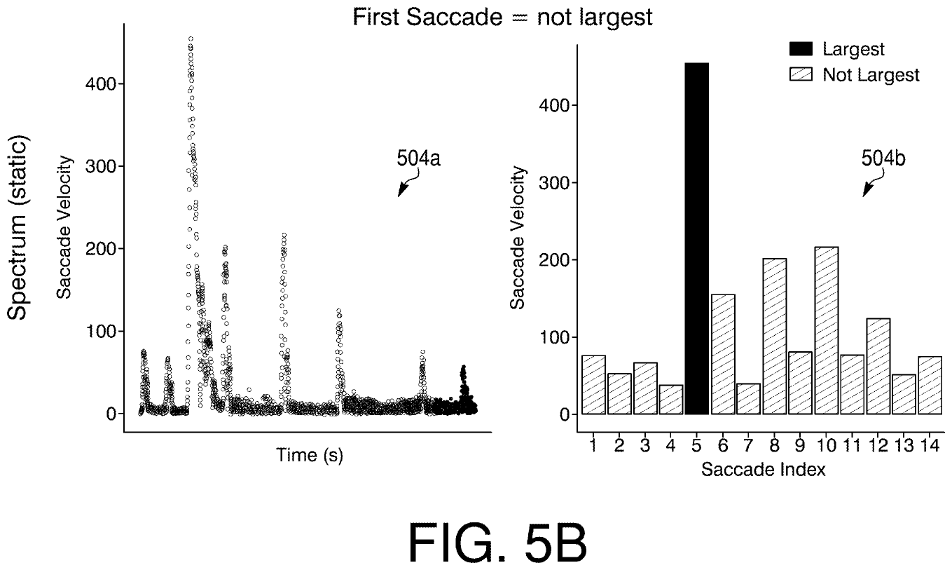

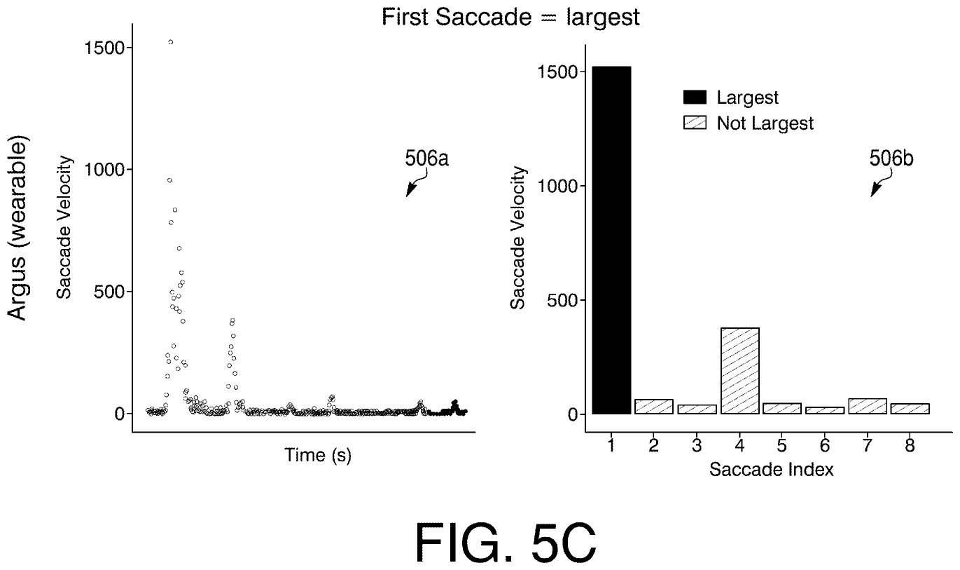

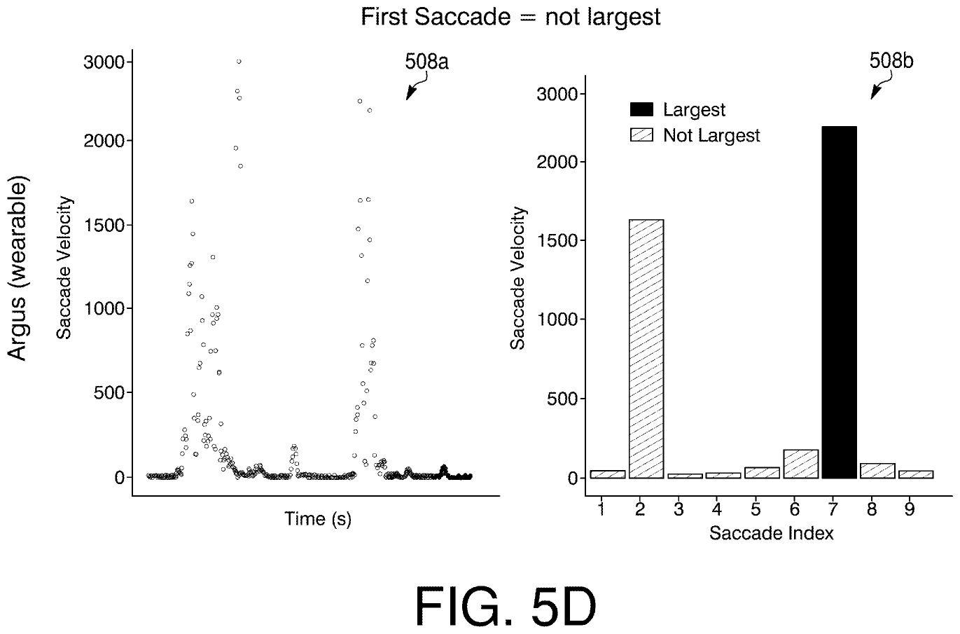

In a subset of trials, it was also observed smaller saccadic eye movements, both before and after the largest saccade, with generally smaller peak velocities, as shown in FIGS. 5A-5D.

FIGS. 5A-5D show saccade order during the Saccade “LOOK” portion of the MS task. Chart 502a of FIG. 5A shows an example screen-based memory saccade (hollow circles) and corrective saccade (filled-in circles) shown for a trial where the largest saccade is the first saccade, using a static tracker 502b. Chart 504a of FIG. 5B shows where the largest saccade comes after the first saccade (where screen-based memory saccades are represented by hollow circles and corrective saccades are represented by filled-in circles), using the static tracker 504b. Chart 506a of FIG. 5C shows similar data as FIG. 5A for the wearable eye-tracker (where screen-based memory saccades are represented by hollow circles and corrective saccades are represented by filled-in circles). As shown in corresponding static tracker 506b of FIG. 5C, the largest saccade is the first saccade. Chart 508a of FIG. 5D shows similar data as FIG. 5B for the wearable eye-tracker (where screen-based memory saccades are represented by hollow circles and corrective saccades are represented by filled-in circles). As shown in corresponding static tracker 508b of FIG. 5D, the largest saccade comes after the first saccade.

The study discussed above was developed for comparing saccadic metrics derived from the same data processing algorithm applied to raw data collected via two infrared eye-tracking devices (mobile and static) in healthy adults. The study may be used to evaluate whether relatively low-cost mobile eye-tracking devices can provide comparable eye movement characteristics to costly high-end static eye-tracking devices. A prerequisite to use such devices in clinical development may be to have such standardized algorithms available. Although both mobile and stationary eye-tracking systems can provide saccadic characteristics using the same algorithm, the implementations disclosed herein, including the study, demonstrate that there are important factors that impact raw data collection pertaining to a mobile device that may not be present in traditional stationary systems. Such algorithms for wearable eye-tracking systems may be generated based on implementations disclosed herein.

The performance of the mobile and static eye-tracking systems may be evaluated by having participants complete the same memory-guided saccade (MS) task on two separate occasions, with data from both systems processed using the same algorithm (I-VT). These testing conditions may be used to determine the accuracy of the mobile eye-tracker compared to the static device. The study above showed that the static device had lower latency values (faster saccade response times) compared to the wearable device, which may be due to the higher resolution of the static device allowing for more accurate measurement of eye movements. The study also found that the Argus device had higher variability in detecting physiologic saccades and detected numerous saccades with non-physiological features. These findings suggest that wearable devices may be less accurate than screen-based devices due to their lower resolution. The relationship between resolution and accuracy in eye-tracking devices and how these differences may impact clinical applications may be determined.

During the memory saccade portion of the MS task, it was observed that the largest saccade was not always the first saccade, with smaller saccadic eye movements observed both before and after the large saccade towards the target in many cases, as shown in table 400 of FIG. 4C. While these smaller eye movements may be expected, as saccades undershoot stationary targets and generally account for only approximately 90% for the distance between the eye and target, this observation may constitute important biological information in the eye-tracking data. Eye movement data may be analyzed, as algorithms that derive saccadic metrics may be either combining the large initial saccade with the smaller corrective saccade, or analyzing them separately, which may lead to different results.

In the study discussed above, data were collected in separate sessions for the two eye-tracking systems, rather than simultaneously. Eye movements can be influenced by several factors that may change over time or between testing sessions and therefore not collecting the data simultaneously on the two devices may limit the ability to assess both accuracy and precision. This challenge is an issue when attempting to deconvolute eye-tracking data. The ability to collect simultaneous data from the two eye-trackers depends on the ability for both eye-trackers to adequately view the eye, which may be limited when deploying mobile eye-trackers that have cameras placed in front of the eyes (e.g., blocking the view from other systems). To overcome this in a reasonable manner, a same set-up and task are implemented. According to an alternative implementation, data may be collected simultaneously from a mobile and static device. For example, data may be collected simultaneously using either infrared or other applicable techniques. The large age range of the study participants may result in a biological source of variability as well as the small sample size.

The study disclosed herein provides findings in the data from the mobile eye-tracker that may indicate that raw data is influenced by a range of technological (e.g., device or analysis) and study protocol (e.g., device set up or data collection) factors. Various human factors may also impact the data between the mobile and static sessions. For example, fatigue between sessions, a learning effect of repeating the same MS task, an emotional state, and/or motivation may impact the comparison of the outcomes.

In terms of technological and protocol factors, the view of eye curvature from the two separate devices may introduce some error, such as for the mobile eye-tracker. Eyes have convex curved lenses that infrared eye-trackers may track using the darkness of the pupil (and the corneal reflections), with the circular pupil shape being necessary for detection. With different devices that are placed in different locations (e.g., one stationary on the desk with full frontal view of the eye, and one on the head with cameras located below the eyes), there may be differences in the detection of the pupils between systems. Accordingly, the mobile device may produce more large saccade values that may not be biologically possible, such as during larger saccades when the person looks furthest away from the camera, where there may be flickers (e.g., movement of the eye-tracking cursor to a black point that is not the pupil), or lost data. For example, in the study disclosed herein, the mobile device reported saccades with velocities over approximately 1,000 deg/s, which may not be physiologically possible, and over approximately 15-20 degrees in amplitude, which may be coupled with a head movement. Most natural saccades occur under approximately 15 degrees. Indeed, pupil tracking may be impacted by a range of factors such as calibration procedures involved in the devices (with the static and mobile devices using different calibration methods), as well as long or drooping eye lashes/lids, make-up, hair obstruction, and/or slippage of the mobile eye-tracker from original calibrated position. While many of these factors can be controlled, some may be reliant on an ability to identify and deal with these issues and are only amplified in a clinical setting. According to implementations of the disclosed subject matter, such factors may be controlled to determine their impact on mobile eye-tracking results.

The observation of involuntary microsaccadic movements before and after an intentional large saccade during the saccade portion of the MS task may be a source of biological information that may be linked to disease states. Implementations of the disclosed subject matter may be used to determine biological variability within and between subjects.

The disclosed subject matter demonstrates that saccadic outcomes can be derived from a relatively low-cost mobile eye-tracking device and a costly research-grade static eye-tracking device when evaluating the same standardized eye movement task in healthy adults. The mobile eye-tracking data may suggest that internal (participant related), and external (device or study protocol related) factors impact the raw data and saccadic output comparability across eye-tracking systems. According to implementations of the disclosed subject matter, factors that impact mobile eye-tracking data may be controlled to determine whether data accuracy could be improved, which may support deployment of systems and techniques disclosed herein within clinical or community/home-based settings or cohorts.

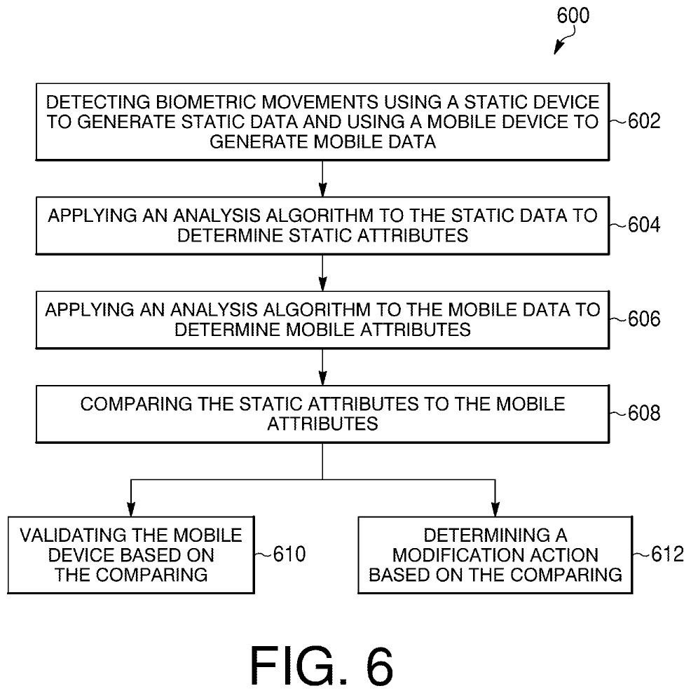

FIG. 6 shows a flowchart 600 for comparing static attributes to mobile attributes. At step 602, biometric movements of a user may be detected using a static biometric device (static movements) and using a mobile biometric device (mobile movements). The static movements and the mobile movements may be detected at different times or at the same time, as disclosed herein. Biometric movements may be detected by one or more sensors in response to a task performed by a user or in response to any applicable trigger (e.g., a device activation, an input, an output, etc.). Static data (e.g., raw data) may be generated based on the static movements and mobile data (e.g., raw data) may be generated based on the mobile movements. For example, static movements and/or mobile movements may be detected using the techniques discussed in reference to FIG. 1.

At step 604, an analysis algorithm (e.g., a Velocity-Threshold Identification (I-VT) algorithm) may be applied to the static data (also referred to as static device data). Static attributes (e.g., amplitude, velocity, duration, latency, etc.) of the static data may be determined based on the application of the analysis algorithm to the static data. For example, an analysis algorithm may be applied to determine the static attributes discussed in reference to FIG. 2 (e.g., via segments 212, 214, 216, 218, and/or 220).

At step 606, the analysis algorithm may be applied to the mobile data (also referred to as mobile device data). Mobile attributes (e.g., amplitude, velocity, duration, latency, etc.) of the mobile data may be determined based on the application of the analysis algorithm to the static data. For example, an analysis algorithm may be applied to determine the mobile attributes discussed in reference to FIG. 2 (e.g., via segments 202, 204, 206, 208, and/or 210).

According to embodiments of the disclosed subject matter, static and/or mobile attributes may be determined using one or more machine learning models (e.g., attribute machine learning models). Such machine learning models may be trained based on training data that includes historical or simulated static data, mobile data, static attributes, and/or mobile attributes. Such training data may be tagged or untagged such that the training may be supervised, semi-supervised or unsupervised. One or more trained machine learning models may receive, as inputs raw data (e.g., raw static data and/or raw mobile data). Based on the raw data, the one or more machine learning models may output the static attributes and/or mobile attributes. For example, a first machine learning model may be trained to output static data based on raw static data inputs. The first machine learning model may be trained to output the static data further based on a characteristic of the static device. A second machine learning model may be trained to output mobile data based on raw mobile data inputs. The second machine learning model may be trained to output the mobile data further based on a characteristic of the mobile device.

At step 608, the static attributes may be compared to the mobile attributes. The comparison may include comparing each static attribute to each corresponding mobile attribute. Alternatively, or in addition, a representation of all static attributes may be compared to a representation of all mobile attributes.

A determination may be made whether the mobile attributes are comparable to the static attributes. For example, a determination may be made whether the mobile attribute are within threshold parameters of static attributes. At step 610, the mobile biometric device may be validated based on a determination that the mobile attributes are within the threshold parameters of the static attributes. According to embodiments of the disclosed subject matter, the determination of whether mobile attributes are within the threshold parameters of the static attributes may be made by one or more machine learning models (e.g., difference machine learning models). Such machine learning models may be trained based on training data that includes historical or simulated static attributes, mobile attributes, difference parameters (e.g., amount of difference, positive differences, negative differences, etc.), difference criteria (e.g., prioritizing one or more attributes), and/or the like. Such training data may be tagged or untagged such that the training may be supervised, semi-supervised or unsupervised. Such machine learning models may be configured to, for example, weight certain attribute differences different than certain other attribute differences. For example, such machine learning models may be trained to apply weights to attribute differences based on the historical or simulated difference parameters or difference criteria. Such one or more trained machine learning models may receive, as inputs, static attributes and/or mobile attributes (e.g., from one or more attribute machine learning models). Based on the received attributes, the one or more machine learning models may output a comparison of mobile attributes to static attributes and/or may output a determination whether the differences are within a threshold amount or vector.

At step 612, a modification action may be determined based on comparing the static attributes to the mobile attributes at step 608. The modification action may include, for example, a modification of the analysis algorithm for application to subsequent mobile data. For example, the analysis algorithm may be modified to generate a modified analysis algorithm. Application of the modified analysis algorithm to subsequent mobile biometric device data may result in attributes that more closely match static attributes. Accordingly, a modified analysis algorithm may be generated to align results of a mobile device with a static device.

Alternatively, or in addition, the modification action may include, for example, a design change to the mobile device. Such a design change may be output based on the comparison at step. For example, based on the comparison of mobile attributes and static attributes, a determination may be made that a mobile device (e.g., wearable device) resolution is insufficient. A minimum resolution may be determined based on comparing the mobile attributes of a given mobile device to the static attributes of a given static device. Steps 602-612 may be iterated to test an updated mobile device design until, for example, mobile attributes are within the threshold parameters of the static attributes (e.g., an update mobile device design is validated at step 610). Such iteration may be conducted using updated physical mobile devices and/or by stimulating updated mobile devices. An updated mobile device may be designed and/or generated based on the design change.

Alternatively, or in addition, the modification action may include, for example, a determination of and/or a change of one or more factors (e.g., participant-related factors, technology-related factors, protocol-related factors, etc.) that contribute to differences in mobile attributes and static attributes. Additionally, effects of the one or more factors (e.g., participant-related factors, technology-related factors, protocol-related factors, etc.) that contribute to differences in mobile attributes and static attributes may be identified based on comparing mobile attributes and static attributes. Such effects may include changes in characteristics (e.g., amplitude, degree, phase, frequency, etc.) of mobile attributes in comparison to static attributes based on use of a mobile device or static device.

According to an implementation, static values and/or mobile values determined based on applying an analysis algorithm to static data or mobile data may be output as an endpoint to a clinical trial. The output may be to one or more devices, to one or more machine learning models, to a report generation component, or the like.

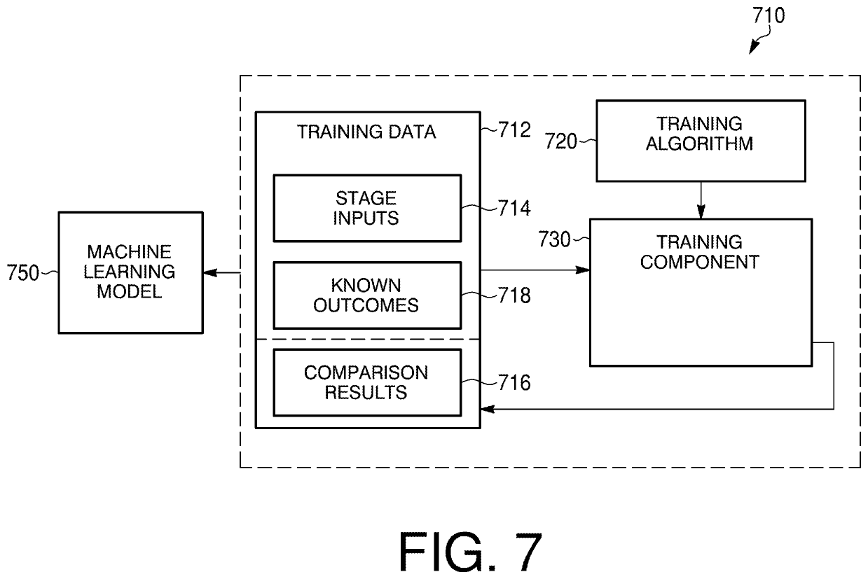

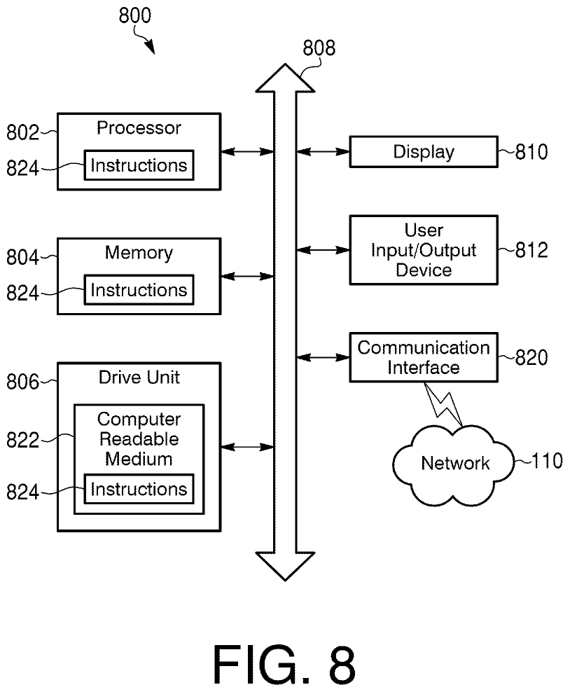

One or more implementations disclosed herein may be implemented using a machine learning model 750 of FIG. 7. Such a machine learning model may be trained using the data flow 710 of FIG. 7. Training data 712 may include one or more of stage inputs 714 and known outcomes 718 related to a machine learning model to be trained. The stage inputs 714 may be from any applicable source including data input or output from a component, step, or module discussed herein (e.g., static and/or mobile devices) and/or as shown in FIGS. 1-7, and/or FIG. 8. The known outcomes 718 may be included for machine learning models generated based on supervised or semi-supervised training. An unsupervised machine learning model may not be trained using known outcomes 718. Known outcomes 718 may include known or desired outputs for future inputs similar to or in the same category as stage inputs 714 that do not have corresponding known outputs.

The training data 712 and a training algorithm 720 may be provided to a training component 730 that may apply the training data 712 to training algorithm 720 to generate a machine learning model. According to an implementation, training component 730 may be provided comparison results 716 that compare a previous output of the corresponding machine learning model to apply the previous result to re-train the machine learning model. Comparison results 716 may be used by training component 730 to update the corresponding machine learning model. Training algorithm 720 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. Training algorithm 720 may modify one or more of weights, layers, nodes, synopsis, or the like of an initial machine learning model to generate machine learning model 750 based on the training data 712 and training component 730.

FIG. 8 is a simplified functional block diagram of a computer system 800 that may be configured as a device for executing the techniques disclosed herein, according to exemplary embodiments of the present disclosure. Computer system 800 may generate features, statistics, analysis, and/or another system according to exemplary embodiments of the present disclosure. In various embodiments, any of the systems (e.g., computer system 800) disclosed herein may be an assembly of hardware including, for example, a data communication interface 820 for packet data communication. The computer system 800 also may include a central processing unit (“CPU”) 802, in the form of one or more processors, for executing program instructions 824. The computer system 800 may include an internal communication bus 808, and a storage unit 806 (such as ROM, HDD, SDD, etc.) that may store data on a computer readable medium 822, although the computer system 800 may receive programming and data via network communications (e.g., over a network 110). The computer system 800 may also have a memory 804 (such as RAM) storing instructions 824 for executing techniques presented herein, although the instructions 824 may be stored temporarily or permanently within other modules of computer system 800 (e.g., processor 802 and/or computer readable medium 822). The computer system 800 also may include input and output ports 812 and/or a display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, a mobile device, a wearable device, an application, or the like. Also, the presently disclosed embodiments may be applicable to any type of Internet protocol.

It will be apparent to those skilled in the art that various modifications and variations can be made in the disclosed devices and methods without departing from the scope of the disclosure. Other aspects of the disclosure will be apparent to those skilled in the art from consideration of the specification and practice of the features disclosed herein. It is intended that the specification and examples be considered as exemplary only.

Embodiments of the present disclosure may include the following items features:

Item 1. A method comprising:
receiving static device data in response to detected first biometric movements;
receiving mobile device data in response to detected second biometric movements;
applying an analysis algorithm to the static data to determine static attributes;
applying the analysis algorithm to the mobile data to determine mobile attributes;
comparing the static attributes to the mobile attributes; and
determining a modification action based on the comparing.

Item 2. A method comprising:
receiving static device data in response to detected first biometric movements;
receiving mobile device data in response to detected second biometric movements;
applying an analysis algorithm to the static data to determine static attributes;
applying the analysis algorithm to the mobile data to determine mobile attributes;
determining that the static attributes are within a threshold parameter of the mobile attributes; and
validating a mobile device based on the determining that the static attributes are within a threshold parameter of the mobile attributes.

Item 3. The method of any of the preceding items, wherein the static device data is generated by a static device.

Item 4. The method of any of the preceding items, wherein the mobile device data is generated by a mobile device.

Item 5. The method of item 4, wherein the mobile device is a wearable device.

Item 6. The method of any of the preceding items, wherein the first biometric movements and the second biometric movements are saccades.

Item 7. The method of any of the preceding items, wherein the static device data or the mobile device data is raw data.

Item 8. The method of any of the preceding items, wherein the analysis algorithm is a Velocity-Threshold Identification (I-VT) eye-tracker algorithm.

Item 9. The method of any of items 4-8, wherein the static device operates at a higher resolution than the mobile device.

Item 10. The method of any of items 5-9, wherein the static device operates at a higher refresh-rate than the mobile device.

Item 11. The method of any of the preceding items, wherein the first biometric movements are the same as the second biometric movements.

Item 12. The method of any of the preceding items, wherein the first biometric movements or the second biometric movements are detected during performance of a task.

Item 13. The method of any of the preceding items, wherein the first biometric movements or the second biometric movements are detected during performance of a memory saccade task.

Item 14. The method of any of the preceding items, wherein the static attributes or the mobile attributes comprise one or more of a velocity, an amplitude, a duration, or a latency.

Item 15. The method of any of the preceding items, wherein the static attributes or the mobile attributes comprise one or more of a saccadic velocity, a saccadic amplitude, a saccadic duration, or a saccadic latency.

Item 16. The method of any of the preceding items, wherein the static attributes or the mobile attributes comprise one or more of a fixation attribute, a target shown attribute, a maintain fixation attribute, a saccade attribute, or a correction attribute.

Item 17. The method of any of the preceding items, wherein the static attributes or the mobile attributes comprise one or more of a time to first saccade, a largest first saccade, a largest non-first saccade, total saccades, or a number of saccades within a duration.

Item 18. A system comprising:
a static device comprising at least one first sensor to detect first biometric movements;
a mobile device comprising at least one second sensor to detect second biometric movements;
a processor;
a computer-readable data storage device storing instructions that, when executed by the processor, cause the system to:
receive static device data based on the first biometric movements;
receive mobile device data based on the second biometric movements;
apply an analysis algorithm to the static data to determine static attributes;
apply the analysis algorithm to the mobile data to determine mobile attributes;
compare the static attributes to the mobile attributes; and
determine a modification action based on the comparing.

Item 19. A system comprising:
a static device comprising at least one first sensor to detect first biometric movements;
a mobile device comprising at least one second sensor to detect second biometric movements;
a processor;
a computer-readable data storage device storing instructions that, when executed by the processor, cause the system to:
receive static device data based on the first biometric movements;
receive mobile device data based on the second biometric movements;
apply an analysis algorithm to the static data to determine static attributes;
apply the analysis algorithm to the mobile data to determine mobile attributes;
determine that the static attributes are within a threshold parameter of the mobile attributes; and
validate the mobile device based on the determining that the static attributes are within a threshold parameter of the mobile attributes.

Item 20. The system of any of items 18-19, wherein the mobile device is a wearable device.

Item 21. The system of any of items 18-20, wherein the first biometric movements and the second biometric movements are saccades.

Item 22. The system of any of items 18-21, wherein the static device data or the mobile device data is raw data.

Item 23. The system of any of items 18-22, wherein the analysis algorithm is a Velocity-Threshold Identification (I-VT) eye-tracker algorithm.

Item 24. The system of any of items 18-23, wherein the static device operates at a higher resolution than the mobile device.

Item 25. The system of any of items 18-24, wherein the static device operates at a higher refresh-rate than the mobile device.

Item 26. The system of any of items 18-25, wherein the first biometric movements are the same as the second biometric movements.

Item 27. The system of any of items 18-26, wherein the first biometric movements or the second biometric movements are detected during performance of a task.

Item 28. The system of any of items 18-27, wherein the first biometric movements or the second biometric movements are detected during performance of a memory saccade task.

Item 29. The system of any of items 18-28, wherein the static attributes or the mobile attributes comprise one or more of a velocity, an amplitude, a duration, or a latency.

Item 30. The system of any of items 18-29, wherein the static attributes or the mobile attributes comprise one or more of a saccadic velocity, a saccadic amplitude, a saccadic duration, or a saccadic latency.

Item 31. The system of any of items 18-30, wherein the static attributes or the mobile attributes comprise one or more of a fixation attribute, a target shown attribute, a maintain fixation attribute, a saccade attribute, or a correction attribute.

Item 32. The system of any of items 18-31, wherein the static attributes or the mobile attributes comprise one or more of a time to first saccade, a largest first saccade, a largest non-first saccade, total saccades, or a number of saccades within a duration.

Item 33. A method comprising:
receiving static device data in response to detected first biometric movements;
receiving mobile device data in response to detected second biometric movements;
applying an analysis algorithm to the static data to determine static attributes;
applying the analysis algorithm to the mobile data to determine mobile attributes;
outputting at least one of the static attributes or the mobile attributes.

Item 34. The method of item 33, wherein the at least one of the static attributes or the mobile attributes are output as an endpoint in a clinical trial.

What is claimed is:

1. A method comprising:
receiving static device data in response to detected first biometric movements;
receiving mobile device data in response to detected second biometric movements;
applying an analysis algorithm to the static device data to determine static attributes;
applying the analysis algorithm to the mobile device data to determine mobile attributes;
comparing the static attributes to the mobile attributes; and
determining a modification action based on the comparing.

2. The method of claim 1, wherein the static device data is generated by a static device and the mobile device data is generated by a mobile device, wherein the mobile device is a wearable device.

3. The method of claim 2, wherein the static device has at least one of a higher resolution or a higher refresh-rate than the mobile device.

4. The method of claim 1, wherein the first biometric movements and the second biometric movements are saccades.

5. The method of claim 1, wherein the static device data or the mobile device data is raw data.

6. The method of claim 1, wherein the analysis algorithm is a Velocity-Threshold Identification (I-VT) eye-tracker algorithm.

7. The method of claim 1, wherein the first biometric movements are the same as the second biometric movements, each of the first biometric movements and the second biometric movements detected during performance of a same respective memory saccade task.

8. The method of claim 1, wherein the static attributes or the mobile attributes comprise one or more of a velocity, an amplitude, a duration, or a latency.

9. The method of claim 1, wherein the static attributes or the mobile attributes comprise one or more of a saccadic velocity, a saccadic amplitude, a saccadic duration, or a saccadic latency.

10. The method of claim 1, wherein the static attributes or the mobile attributes comprise one or more of a fixation attribute, a target shown attribute, a maintain fixation attribute, a saccade attribute, or a correction attribute.

11. The method of claim 1, wherein the static attributes or the mobile attributes comprise one or more of a time to first saccade, a largest first saccade, a largest non-first saccade, total saccades, or a number of saccades within a duration.

12. A method comprising:
receiving static device data in response to detected first biometric movements;
receiving mobile device data in response to detected second biometric movements;
applying an analysis algorithm to the static device data to determine static attributes;
applying the analysis algorithm to the mobile device data to determine mobile attributes;
determining that the static attributes are within a threshold parameter of the mobile attributes; and
validating a mobile device based on the determining that the static attributes are within a threshold parameter of the mobile attributes.

13. The method of claim 12, wherein the static device has at least one of a higher resolution or a higher refresh-rate than the mobile device.

14. The method of claim 12, wherein the analysis algorithm is a Velocity-Threshold Identification (I-VT) eye-tracker algorithm.

15. The method of claim 12, wherein the first biometric movements or the second biometric movements are detected during performance of a memory saccade task.

16. The method of claim 12, wherein the static attributes or the mobile attributes comprise one or more of a time to first saccade, a largest first saccade, a largest non-first saccade, total saccades, or a number of saccades within a duration.

17. A system comprising:
a static device comprising at least one first sensor to detect first biometric movements;
a mobile device comprising at least one second sensor to detect second biometric movements;
a processor; and
a computer-readable data storage device storing instructions that, when executed by the processor, cause the system to:
receive static device data based on the first biometric movements;
receive mobile device data based on the second biometric movements;
apply an analysis algorithm to the static device data to determine static attributes;
apply the analysis algorithm to the mobile device data to determine mobile attributes;
compare the static attributes to the mobile attributes; and
determine a modification action based on the comparing.

18. The system of claim 17, wherein the static device has at least one of a higher resolution or a higher refresh-rate than the mobile device.

19. The system of claim 17, wherein the first biometric movements are the same as the second biometric movements, each of the first biometric movements and the second biometric movements detected during performance of a same respective memory saccade task.

20. The system of claim 17, wherein the static attributes or the mobile attributes comprise one or more of a fixation attribute, a target shown attribute, a maintain fixation attribute, a saccade attribute, or a correction attribute.
